(19) United States
(12) Patent Application Publication
(10) Pub. No.: US 2016/0063586 A1
(43) Pub. Date: Mar. 3, 2016

(54) ONLINE SYSTEM AND METHOD FOR FACILITATING THE SALE AND PURCHASE OF ITEMS

(71) Applicant: Ryan J. Speier, Boca Raton, FL (US)

(72) Inventor: Ryan J. Speier, Boca Raton, FL (US)

(21) Appl. No.: 14/472,286

(22) Filed: Aug. 28, 2014

(51) Int. Cl. G06Q 30/06; G06Q 50/00

(52) U.S. Cl. CPC G06Q 30/0617; G06Q 50/01

(57) ABSTRACT

A computer implemented method is provided for facilitating the online selling and purchasing of items, comprising: receiving in a facilitator a post from a seller having an item to sell; providing the seller's post to a broker who is accessing the facilitator; receiving in the facilitator a first purchase request from a first buyer who learned about the item from the broker, the first purchase request including an identification code provided by the broker; receiving in the facilitator payment information, less any discount offered by the broker, from the first buyer; upon receipt in the facilitator of an indication that the first buyer has received the item from the seller, providing the seller with the purchase price, less any commission offered by the seller and less the discount; and providing the broker with the commission, less the discount.

### TECHNICAL FIELD

The present invention pertains generally to e-commerce and, in particular, to a web-based system and method for conducting and facilitating the sale and purchase of items.

### BACKGROUND ART

Numerous internet websites are available for people to post items for sale. Prospective buyers may review postings and, if they find an item that they want to purchase, purchase the item either directly from the seller (using Craig's List, for example) or through the website (eBay, for example).

### SUMMARY OF THE INVENTION

In one embodiment, the present invention provides a computer implemented method for facilitating the online selling and purchasing of items, comprising: receiving in a facilitator a post from a seller having an item to sell, the post including information about the item, a purchase price, and an amount of any sales commission; providing the seller's post to a broker who is accessing the facilitator; receiving in the facilitator a first purchase request from a first buyer who learned about the item from the broker, the first purchase request including a code provided by the broker, the code including an identification of the broker, the item, and an amount of any discount offered by the broker to the first buyer; receiving in the facilitator payment information, less the discount, from the first buyer; upon receipt in the facilitator of an indication that the first buyer has received the item from the seller, providing the seller with the purchase price, less the commission and discount; and providing the broker with the commission, less the discount.

In another embodiment, the present invention provides a networked online marketplace facilitator, comprising: a processor; a plurality of network portals coupled to the processor and configured to interconnect sellers of items, prospective buyers of items, and brokers through the facilitator; and memory coupled to the processor. The memory is configured to store instructions for: receiving in the facilitator a post from a seller having an item to sell, the post including information about the item, a purchase price, and an amount of any sales commission; providing the seller's post to a broker who is accessing the facilitator; receiving in the facilitator a first purchase request from a first buyer who learned about the item from the broker, the first purchase request including a code provided by the broker, the code including an identification of the broker, the item, and an amount of any discount offered by the broker to the first buyer; receiving in the facilitator payment information, less the discount, from the first buyer; upon receipt in the facilitator of an indication that the first buyer has received the item from the seller, providing the seller with the purchase price, less the commission and discount; and providing the broker with the commission, less the discount.

### BRIEF DESCRIPTION OF THE DRAWINGS

FIG. 1 is a block diagram of an embodiment of a networked on-line marketplace facilitator of the present invention;

FIG. 2 is a block diagram of an embodiment of a facilitator of the facilitator of FIG. 1;

FIG. 3 is a block diagram illustrating a relationship of a seller, buyer and the facilitator of FIG. 2;

FIG. 4 is a block diagram illustrating a relationship of a seller, broker, and the facilitator of FIG. 2;

FIG. 5 is a block diagram illustrating a relationship of a seller, a broker, buyer, and the facilitator of FIG. 2;

FIG. 6 is a flow chart of one process implemented on the facilitator of FIG. 2; and

FIGS. 7A and 7B are a flow chart of another process implemented on the facilitator of FIG. 2.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

Current e-commerce web-based marketplace services are designed to allow buyers and sellers to negotiate and transact the sale of items directly with each other, although payment of the purchase price of an item sold on eBay and other similar services is routed through eBay instead of directly to the seller. The present invention provides an online marketplace that facilitates the sale and purchase of items by accommodating individuals who may not wish to purchase an item but who are able to find those who do outside the sphere of the marketplace itself. These individuals, who are referred to herein as “brokers,” may be anyone and do not actually take possession of the item being sold (except when acting only as buyers) but, rather, provide an avenue to allow the buyer to obtain the item directly from the seller, with payment being routed through the facilitator. Moreover, the facilitator gives a seller the option to offer a commission to brokers as an incentive.

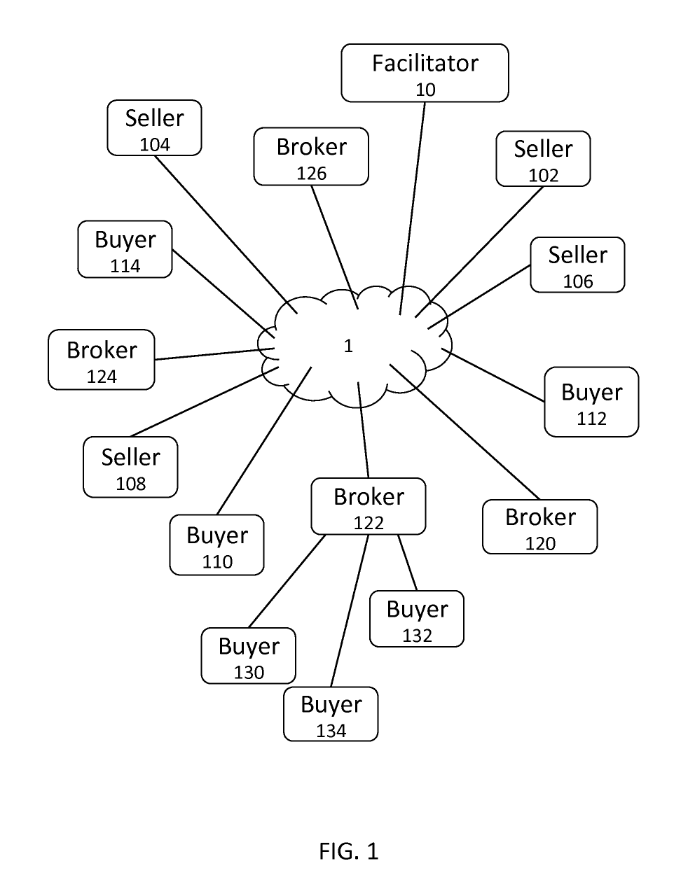

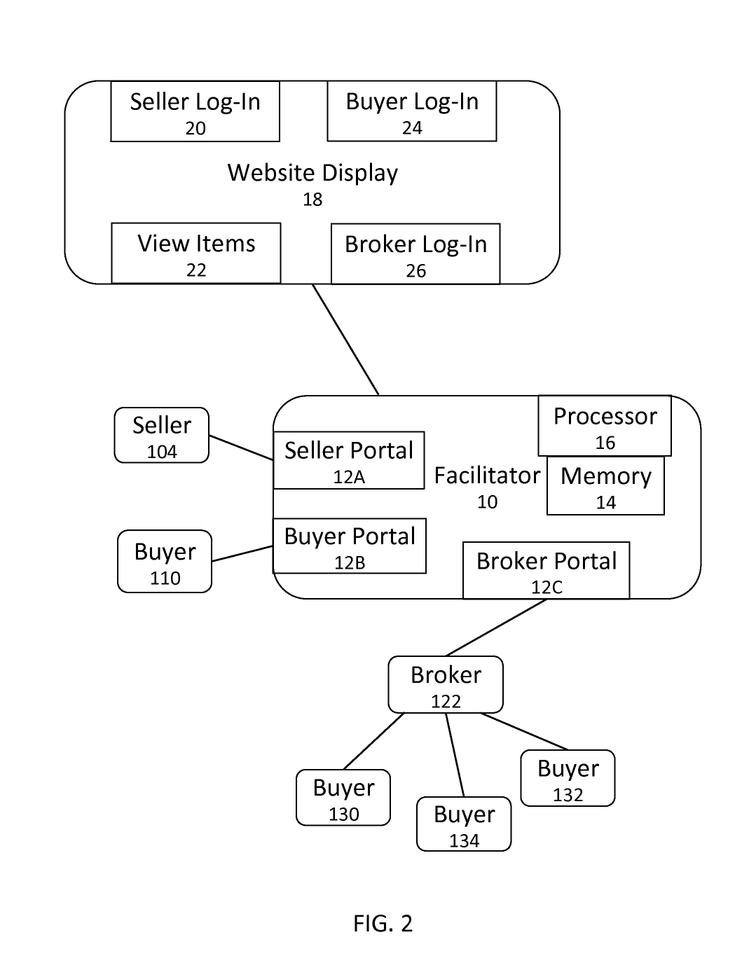

FIG. 1 is a block diagram of an embodiment of a networked on-line marketplace facilitator 10 of the present invention having a connection with the internet 1 or other network to allow sellers 102, 104, 106, and 108 of items, buyers and prospective buyers 110, 112, 114 of items, and brokers 120, 124, 124, 126 to have two-way communication access the facilitator 10. As illustrated in FIG. 2, sellers, buyers, and brokers, represented by the seller 104, the buyer 110, and the broker 122, use the internet 1 to interconnect with the facilitator 10 through seller, buyer, and broker network portals 12A, 12B, 12C, respectively. The facilitator 10 may include a memory 14 and a processor 16 coupled to the portals 12A, 12B, 12C. The memory 14 is configured to store instructions to be executed by the processor 16. The memory 14 is also configured to store a database containing seller, buyer, broker, and item information. It will be appreciated that the single memory 14 block illustrated in FIG. 2 and described herein is merely representative; the instructions and database may be stored on separate physical memory devices. The facilitator 10 may also be configured to provide a website with a display 18 to users over the network 1 to permit sellers, buyers, and brokers, represented again by the seller 104, the buyer 110, and the broker 122, to access the database and view items posted for sale, and log in to view commissions associated with items for sale, and sell, buyer, or broker items. Such access may be provided by selection options that are displayed, such as a seller log-in option 20, a view-items option 22, a buyer log-in option 24, and a broker log-in option 26.

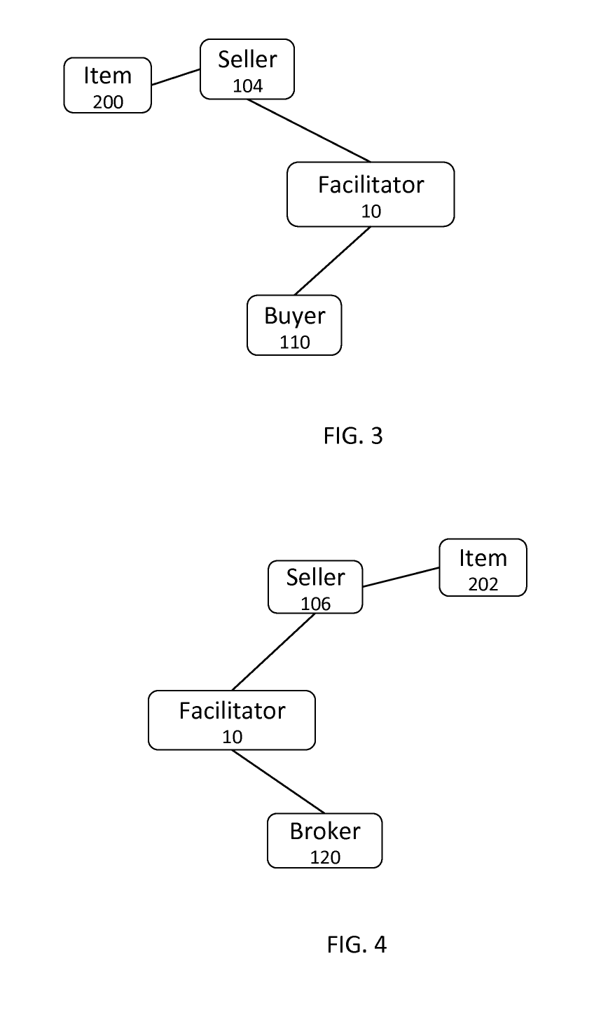

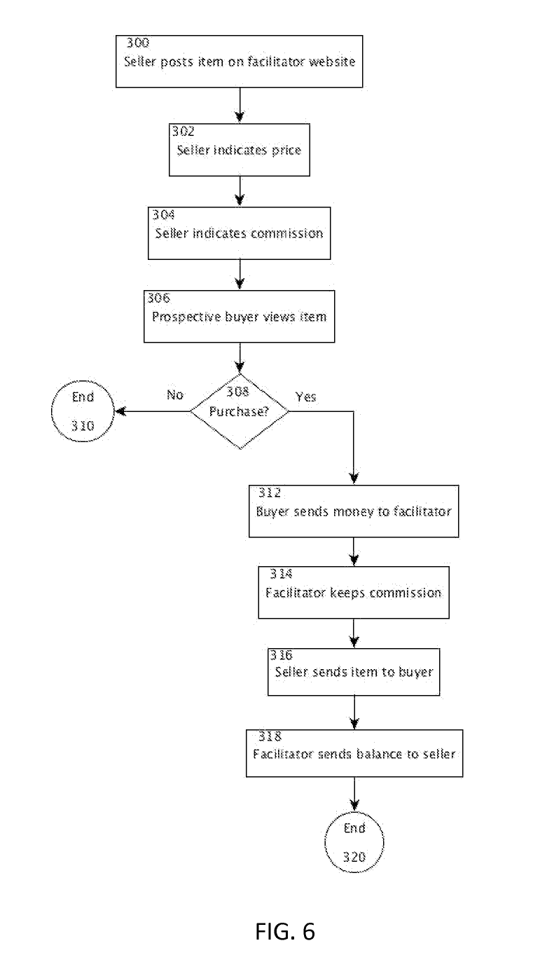

In a first scenario, referring to FIG. 3 and the flowchart of FIG. 5, a seller, such as the seller 104, wishing to offer an item 200 for sale may access the facilitator 10 using the internet 1 and select the seller log-in option 20. The seller 104 posts a description of the item 200 (step 300), perhaps with a photo, indicates the price (step 302), and states the amount of any commission that he or she is will to give (step 304). Such information is stored in the database. If a commission is to be offered, the facilitator may require a minimum amount, such as 1% of the sale price. A typical commission may be up to 5%, or even higher.

A buyer, such as the buyer 110, may also access the facilitator 10 using the internet 1 and select the view-items option 22 to view information about items for sale, including the item 200 being sold by the seller 104 (step 306). If the buyer 110 decides (step 308) not to purchase the item 200, he or she can view other items or exit (step 310). If, instead, the buyer 110 decides (step 308) to purchase the item 200, the buyer 110 may select the buyer log-in option 24 and go through the process of paying for the item 200 (step 312) using any means offered by the facilitator, such as a credit card, PayPal, Braintree, the service's own payment system (“mobile wallet”), or the like. Before forwarding any money to the seller 104, the facilitator retains the full commission (step 314) and waits until it receives confirmation that the buyer 110 has received the item 200 (step 316). The purchase price, less the commission, is then sent to the seller 104 (step 318) and the process ends (step 320). Alternatively, the facilitator may credit an account of the seller 104 with the purchase price, less the commission.

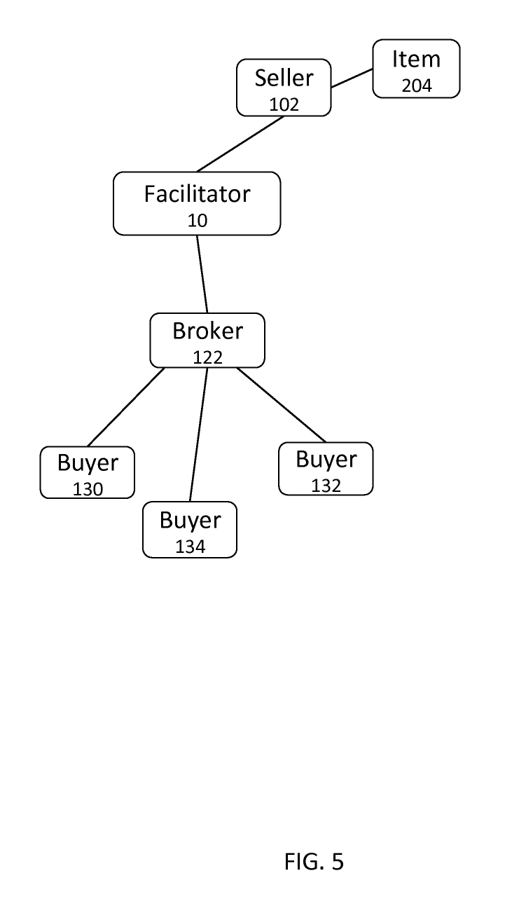

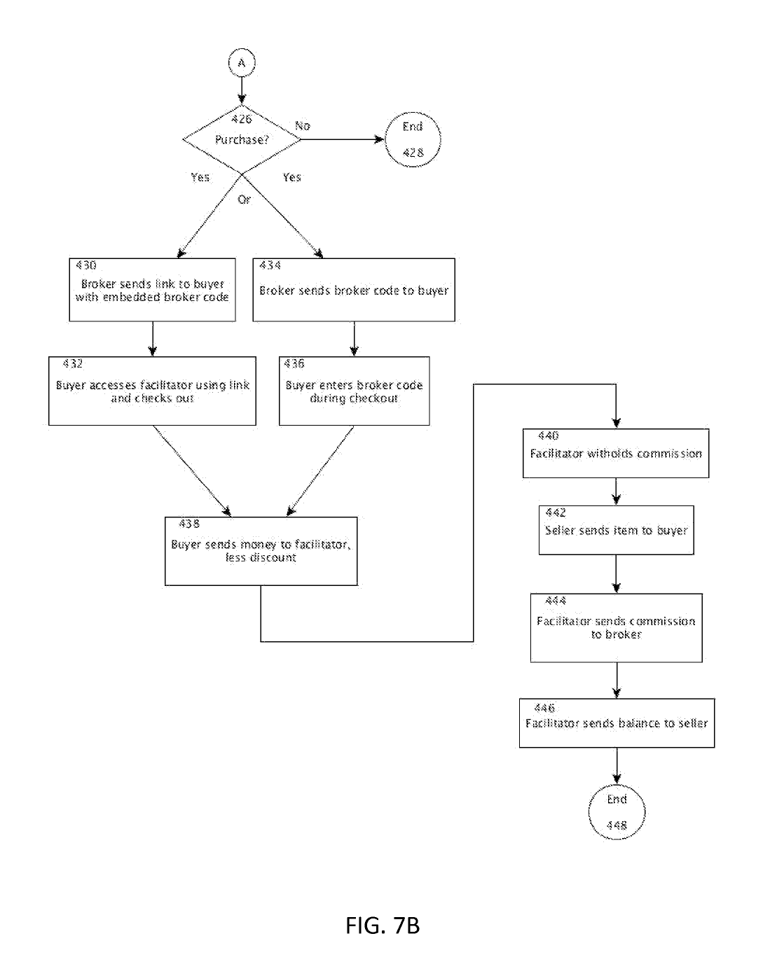

In another scenario, referring to FIG. 4 and the flowchart of FIG. 7A, another seller, such as the seller 106, wishing to offer an item 202 for sale may access the facilitator 10 using the internet 1 and select the seller log-in option 20. As before, the seller 106 posts a description of the item 202 (step 402), perhaps with a photo, indicates the price (step 404), and states the amount of any commission that he or she is willing to give (step 406).

A broker, such as the broker 120, may also access the facilitator 10 using the internet 1 and select the view-items option 22 to view information about items for sale, including the item 202 being sold by the seller 106 (step 408). If the broker 120 decides (step 304) to purchase the item 202 for him/herself, he or she may select the broker log-in option 26, view the commission offered with the item 202, and go through the process of paying for the item 202, paying the purchase price less a predetermined percentage of the commission, such as 50% (step 412). The seller 106 may then send the item 202 to the broker 120 (step 414). Before forwarding any money to the seller 106, the facilitator retains the balance of the commission, such as the remaining 50%, (step 416) and waits until it receives confirmation that the broker 120 has received the item 202. The purchase price, less the commission, is then sent to the seller 106 (step 418). Under a different arrangement, the broker 120 may pay the full purchase price to the facilitator which retains the predetermined percentage of the commission and credits an account of the broker with the balance of the commission.

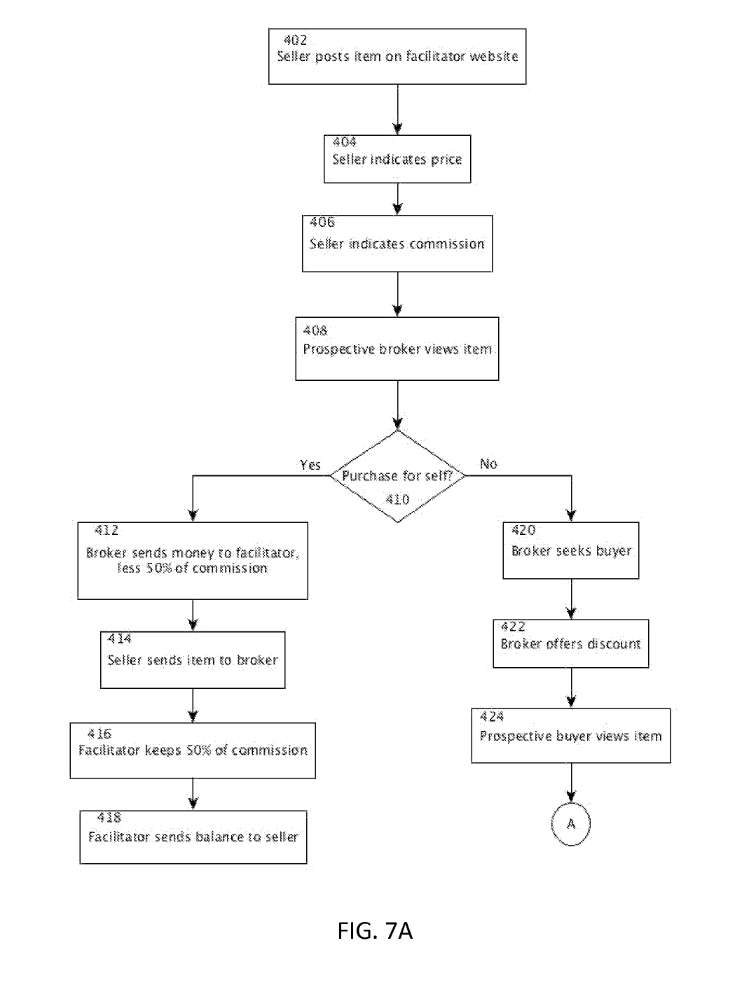

Referring now to FIG. 5 and the flowcharts of FIG. 7A, continuing onto FIG. 7B, a broker 122 may decide (step 410) that he or she can find a buyer for an item 204 offered by a seller 102 instead of purchasing the item 204 for him/herself. Thus, the broker 122 may seek a buyer (step 420) through channels outside of the sphere of the facilitator. In doing so, the broker 122 may be in contact with a number of prospective buyers, such as the representative prospective buyers 130, 132, 134 in FIG. 5. This may be word of mouth, special-interest clubs, conventional advertising, Craig's List, eBay, Facebook, Twitter, Instagram, other social networks, among others, or by any other means. As an incentive for a buyer to purchase the item 204 through the broker 122, the broker 122 may offer a discount off the listed sale price (step 422), thereby sharing the commission with the buyer. A prospective buyer, such as the prospective buyer 130, may view information about the item 204 through the facilitator or through other channels (step 424). The prospective buyer 130 may decide (step 426, FIG. 6B) not to purchase the item 204 and the process ends (step 428). Alternatively, the prospective buyer 130 may decide (step 426) to purchase the item 204.

The broker 122 may then provide to the formerly prospective buyer 130, now an actual buyer, (or may already have provided) a link (step 430) that enables the buyer 130 to directly access the facilitator server 10 and purchase the item 204 (step 432). The link may have a unique code embedded in it that was provided by the facilitator 10 and which identifies the broker 122 and the item 204, and may also identify any discount offered by the broker 122. Alternatively, the broker 122 may provide the broker's unique broker/item/discount code to the buyer 130 (step 434) which the buyer can enter during checkout (step 436) in order to take advantage of the discount offered by the broker 122.

In either event, as part of the check-out process, the buyer 130 pays the purchase price, less the discount, to the facilitator using whatever methods the facilitator makes available (step 438). As before, the facilitator withholds the commission, less the discount, from the purchase price (step 440). After the seller sends the item 204 to the buyer 130 (step 442) and the buyer 130 confirms receipt of the item 204, the facilitator sends the commission, less the discount, to the broker 122 or credits his/her account (step 444) and sends the balance to the seller (step 446). The transaction is then complete (step 448).

In contrast to conventional e-commerce websites, the facilitator of the present invention encourages more widespread dissemination of information about items for sale. By offering a commission, a seller can provide an incentive for brokers to find buyers for an item using avenues, such as personal contact, the broker's special interest clubs, and the broker's social networks, among others, that are unavailable to the seller. For example, an individual wanting to sell a box of old comic books could use the facilitator of the present invention to post information about the comics. Although any prospective buyer could view the information and purchase, a broker having expertise with comic books could also view the information. Such a broker may have contacts within a group of avid comic book collectors and thus may be able to find more knowledgeable prospective buyers who would better appreciate the value of the comics that the seller is selling. Prospective buyers thus have access to items that they might not otherwise know about. The broker can make money by serving as a middle-man in the transaction. And, by offering a discount to prospective buyers that a broker finds, the broker can provide his or her own incentive for a buyer to enter the broker's code during checkout rather than bypassing the broker as in FIGS. 3 and 5, thereby ensuring that the broker receives compensation for his/her efforts.

The description of the present invention has been presented for purposes of illustration and description, but is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A computer implemented method for facilitating the online selling and purchasing of items, comprising:
receiving in a facilitator a post from a seller having an item to sell, the post including information about the item, a purchase price, and an amount of any sales commission;
providing the seller's post to a broker who is accessing the facilitator;
receiving in the facilitator a first purchase request from a first buyer who learned about the item from the broker, the first purchase request including a code provided by the broker, the code including an identification of the broker, the item, and an amount of any discount offered by the broker to the first buyer;
receiving in the facilitator payment information, less the discount, from the first buyer;
upon receipt in the facilitator of an indication that the first buyer has received the item from the seller, providing the seller with the purchase price, less the commission and discount; and
providing the broker with the commission, less the discount.

2. The method of claim 1, further comprising:
providing the seller's post to a second buyer who is accessing the facilitator and who did not learn about the item from the broker;
in lieu of receiving in the facilitator a first purchase request from the first buyer, receiving in the facilitator a second purchase request from the second buyer;
receiving in the facilitator payment information from the buyer; and
upon receipt in the facilitator of an indication that the second buyer has received the item from the seller, providing the seller with the purchase price, less the commission.

3. The method of claim 1, further comprising:
in lieu of receiving in the facilitator a first purchase request from the first buyer, receiving in the facilitator a third purchase request from the broker;
receiving in the facilitator payment information from the broker, less a predetermined percentage of the commission; and
upon receipt in the facilitator of an indication that the broker has received the item from the seller, providing the seller with the purchase price, less the commission.

4. The method of claim 1, further comprising providing a website display from the facilitator, the website display comprising:
a first selection configured to allow sellers to log in and post information about items to be sold;
a second selection configured to allow prospective buyers and brokers to view the items posted for sale;
a third selection configured to allow a buyer to log in and purchase one of the items posted for sale; and
a fourth selection configured to allow a broker to log in, view commissions associated with items for sale, and obtain a unique broker/item identification code to be provided to prospective buyers by the broker.

5. A networked online marketplace facilitator, comprising:
a processor;
a plurality of network portals coupled to the processor and configured to interconnect sellers of items, prospective buyers of items, and brokers through the facilitator; and
memory coupled to the processor and configured to store instructions for:
receiving in the facilitator a post from a seller having an item to sell, the post including information about the item, a purchase price, and an amount of any sales commission;
providing the seller's post to a broker who is accessing the facilitator;
receiving in the facilitator a first purchase request from a first buyer who learned about the item from the broker, the first purchase request including a code provided by the broker, the code including an identification of the broker, the item, and an amount of any discount offered by the broker to the first buyer;
receiving in the facilitator payment information, less the discount, from the first buyer;
upon receipt in the facilitator of an indication that the first buyer has received the item from the seller, providing the seller with the purchase price, less the commission and discount; and
providing the broker with the commission, less the discount.

6. The facilitator of claim 5, the memory further configured to store instructions for:
providing the seller's post to a second buyer who is accessing the facilitator and who did not learn about the item from the broker;
in lieu of receiving in the facilitator a first purchase request from the first buyer, receiving in the facilitator a second purchase request from the second buyer;
receiving in the facilitator payment information from the buyer; and
upon receipt in the facilitator of an indication that the second buyer has received the item from the seller, providing the seller with the purchase price, less the commission.

7. The facilitator of claim 5, the memory further configured to store instructions for:
in lieu of receiving in the facilitator a first purchase request from the first buyer, receiving in the facilitator a third purchase request from the broker;
receiving in the facilitator payment information from the broker, less a predetermined percentage of the commission; and
upon receipt in the facilitator of an indication that the broker has received the item from the seller, providing the seller with the purchase price, less the commission.

8. The facilitator of claim 5, the memory further configured to store instructions for providing a website display from the facilitator, the website display comprising:
a first selection configured to allow sellers to log in and post information about items to be sold;
a second selection configured to allow prospective buyers and brokers to view the items posted for sale;
a third selection configured to allow a buyer to log in and purchase one of the items posted for sale; and
a fourth selection configured to allow a broker to log in, view commissions associated with items for sale, and obtain a unique broker/item identification code to be provided to prospective buyers by the broker.
